(19) United States
(12) Patent Application Publication
(10) Pub. No.: US 2026/0327980 A1
(43) Pub. Date: Oct. 22, 2026

(54) LENGTHS OF SHELL-CORE COMBINATION

(71) Applicant: FYREPANEL (AUST) PTY LTD, Dandenong (AU)

(72) Inventor: John BACON, Seaford (AU)

(21) Appl. No.: 19/646,870

(22) Filed: Apr. 14, 2026

(30) Foreign Application Priority Data
Apr. 15, 2025 (AU) 2025901314

(51) Int. Cl. E04C 2/292; E04B 1/94; E04C 2/34

(52) U.S. Cl. CPC E04C 2/292; E04B 1/942; E04C 2/34

(57) ABSTRACT

A method of forming a member. The member includes a length of shell-core combination for a fire-resistant wall and has a core within a shell. Shell material includes one or more continuous strips and a shell portion. The shell portion defines an interior and includes a respective continuous extension of each respective continuous strip of the one or more continuous strips. The method includes advancing (the shell material in a streamwise direction and through a manipulation system), the manipulation system manipulating (the one or more continuous strips to form the shell portion), supplying (core material to the interior of the shell portion) and severing an end portion from the shell portion. The severing is performed downstream of the supplying.

### FIELD

the field of the disclosure relates to lengths of shell-core combination for fire-resistant walls, although various advantageous details disclosed herein may be usefully employed in other contexts.

### BACKGROUND

Various existing fire-resistant walls comprise lengths of shell-core combination in the form of lengths of tongue-and-groove material each comprising a shell formed from two roll-formed half-shells and filled with cementitious material.

The present inventor has recognised scope to reduce the financial and environmental costs of producing lengths of shell-core combination, to improve the fire-resistance of walls formed thereof and to reduce the risk of silicosis associated therewith. Accordingly, exemplary aspects of the present disclosure aim to provide improvements (or at least alternatives) in (and in the production of) lengths of shell-core combination for fire-resistant walls, albeit that various advantageous details disclosed herein may be employed in other contexts, potentially including contexts far removed from lengths of shell-core combinations and/or fire-resistant walls.

It is not admitted that any of the information in this patent specification is common general knowledge, or that the person skilled in the art could be reasonably expected to ascertain or understand it, regard it as relevant or combine it in any way before the priority date.

### SUMMARY

One aspect of the present disclosure provides a method of forming a member;
wherein the member is a length of shell-core combination for a fire-resistant wall and comprises a core within a shell;
shell material comprises
   one or more continuous strips; and
   a shell portion defining an interior and comprising a respective continuous extension of each respective continuous strip of the one or more continuous strips; and
the method comprises
   advancing the shell material in a streamwise direction and through a manipulation system;
   the manipulation system manipulating the one or more continuous strips to form the shell portion;
   supplying core material to the interior of the shell portion; and
   severing an end portion from the shell portion; and
the severing is downstream of the supplying.

The supplying core material is preferably supplying settable material, in which case the severing is preferably after the settable material within the end portion has set. The method may comprise heating to set the settable material within the end portion.

In certain embodiments, the shell portion comprises
a first side;
a second side;
lengthwise material connecting the first side to the second side and penetrated by openings; and
the method includes occluding the openings in the shell portion to retain the settable material.

Preferably, the one or more continuous strips is exactly one continuous strip.

Another aspect of the present disclosure provides a method of forming a member;

Another aspect of the present disclosure provides a method of forming a member;
wherein the member is a length of shell-core combination for a fire-resistant wall and comprises a core within a shell;
   shell material comprises
      one or more continuous strips; and
      a shell portion defining an interior and comprising a respective continuous extension of each respective continuous strip of the one or more continuous strips; and
   the method comprises
      advancing the shell material in a streamwise direction and through a manipulation system;
      the manipulation system manipulating the one or more continuous strips to form the shell portion;
      severing an end portion from the shell portion; and
      supplying core material; and
   the one or more continuous strips is exactly one continuous strip.

Another aspect of the present disclosure provides a method of forming a member;
wherein the member is a length of shell-core combination for a fire-resistant wall and comprises a core within a shell;
shell material comprises
   one or more continuous strips; and
   a shell portion defining an interior and comprising a respective continuous extension of each respective continuous strip of the one or more continuous strips; and
the method comprises
   advancing the shell material in a streamwise direction and through a manipulation system;
   the manipulation system manipulating the one or more continuous strips to form the shell portion;
   severing an end portion from the shell portion;
   supplying core material; and
the core material comprises at least one of gypsum and recycled fibreglass insulation.

Preferably, the core material comprises gypsum, and most preferably comprises recycled plasterboard. Optionally, the core material comprises recycled fibreglass insulation and/or perlite.

Preferably, the shell is a metallic shell, e.g. a steel shell.

The manipulating may comprise roll-forming.

Another aspect of the present disclosure provides a member for a fire-resistant wall;
wherein the member is a length of shell-core combination for a fire-resistant wall and comprises a core within a shell; and
the shell comprises
   a first side;
   a second side; and
   lengthwise material; and
   the lengthwise material connects the first side to the second side and is penetrated by openings.

In certain embodiments, the openings comprise at least one row of openings along a notional lengthwise line;
along the notional lengthwise line the openings of the row are mutually separated by intervening shell material; and
a cumulative length, along the notional lengthwise line, of the openings is at 50% of a cumulative length, along the notional lengthwise line, of the intervening shell material.

Preferably, the cumulative length, along the notional lengthwise line, of the openings is at 100% of the cumulative length, along the notional lengthwise line, of the intervening shell material.

Optionally, the member comprises
a tongue; and
a groove for receiving the tongue of a like member.

Preferably, the openings penetrate at least one, or more preferably both, of
material of the tongue; and
material of the groove.

Another aspect of the present disclosure provides a method comprising simultaneously
roll-forming material to form tubular portion; and
supplying core material to an interior of the tubular portion.

### BRIEF DESCRIPTION OF DRAWINGS

FIG. 1 is a perspective view of a length of shell;

FIG. 2 is an end view of a length of the shell-core combination of FIG. 1;

FIG. 3 is an enlargement of detail B in FIG. 2;

FIG. 4 schematically illustrates a production line;

FIGS. 5a-5f are cross-section views of respective portions of a continuous length of shell material; and

FIG. 6 is an end view of another length of the shell-core combination.

### DESCRIPTION OF EMBODIMENTS

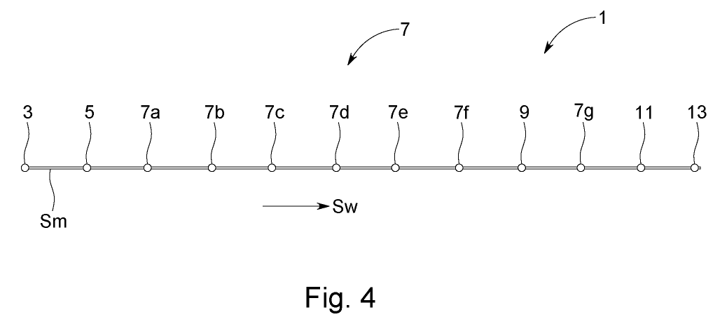

FIG. 4 schematically illustrates a process 1 for producing lengths of shell-core combination in which a continuous (as in unbroken) length of shell material SM moves in a streamwise direction SW. At the upstream end of the process 1 is a coil 3 that provides a continuous strip of material.

“Continuous strip” and similar terminology is used herein in its conventional sense to refer to a strip long enough that, whilst the process operates at steady state, parts can be produced without the upstream end of the strip playing any part in the process, even if periodically the strip supply (e.g. coil 3) is exhausted and must be replenished before the process can recommence.

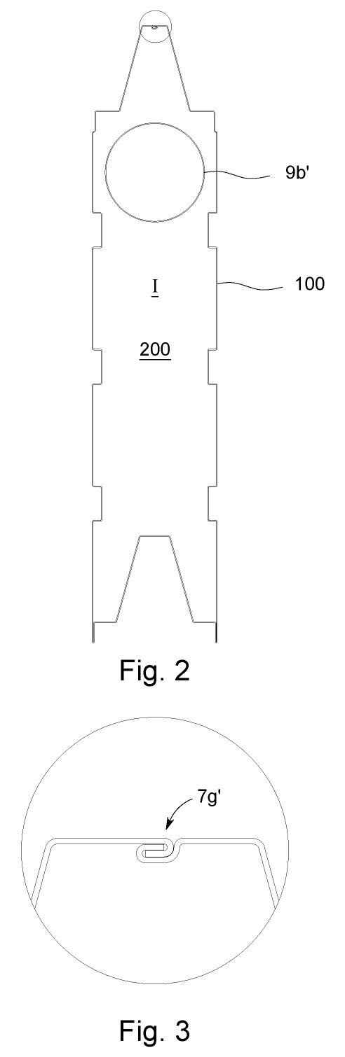

The shell material is a continuous piece comprising the continuous strip and a shell portion (of the profile illustrated in FIG. 2) consisting of a continuous extension of the continuous strip.

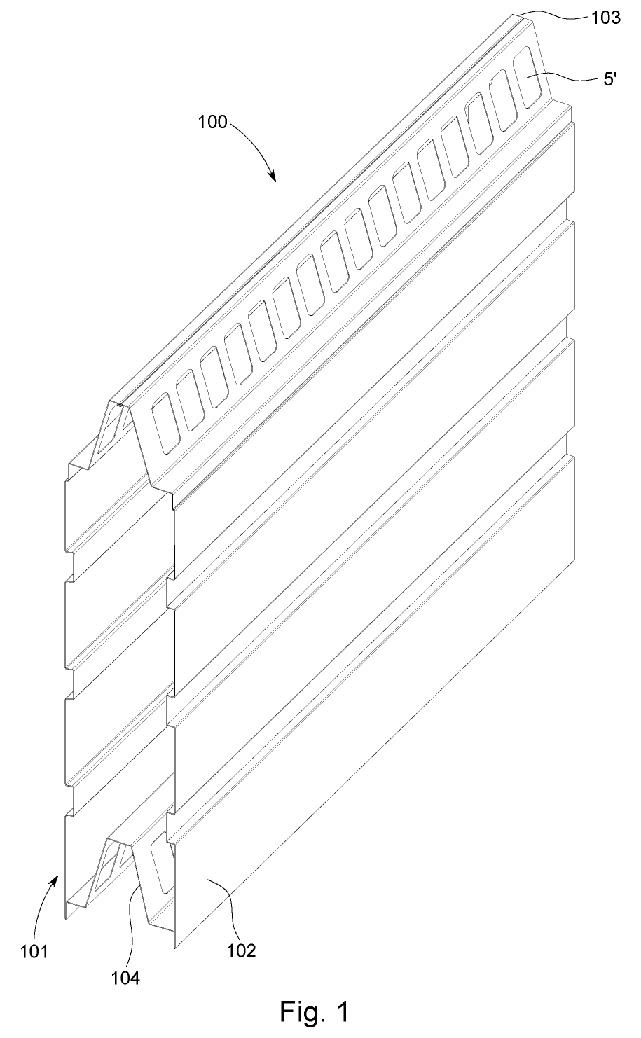

In this example, the strip is a steel strip with a zinc surface treatment and is in the vicinity of 600 mm wide by about 0.4 mm thick. A base metal thickness in the range of 0.3 mm to 0.5 mm is preferred. From the coil 3, the shell material SM moves on to an opening-forming station in the form of punching station 5 at which four rows of windows 5′ (FIG. 1) are punched out. Once the openings are formed, the shell material is advanced through a manipulating system 7. In this example, the manipulating system 7 is a roll-forming system comprising stations 7a to 7g along which the shell material is deformed, from its simple flat form, to form a tubular structure enclosing an interior I (FIG. 2). The shell material is mostly symmetrical along its lengthwise centreline but includes an asymmetric pair of hooks comprising a respective hook on each of its two free edges. Through station 7g, the hooks are engaged and then compressed to form roll-formed seam 7g′ (FIG. 3) closing the profile of the shell portion.

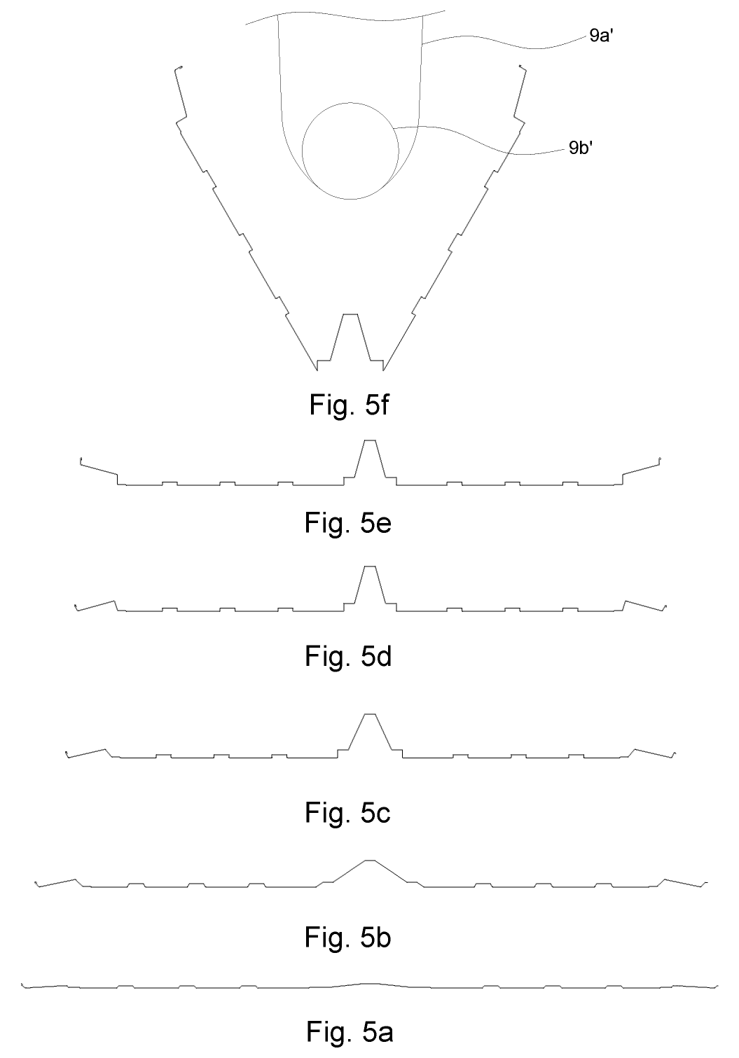

Material injector 9 sits between roll-forming stages 7f, 7g. As schematically illustrated in FIGS. 5f and 5g, the injector 9 comprises a portion 9a′ that projects downwardly into the valley of the upwardly open shell material from which streamwise nozzle 9b′ projects in a downstream direction beyond the roll-forming stage 7g to supply core material to the interior of the shell portion at a location fully surrounded by the walls of the tubular shell portion.

In principle, core material could be supplied in solid form, e.g. a pliable length of core material might be inserted, but preferably the core material is supplied in liquid form. Preferably, the injector 9 injects settable material, e.g. a mix of recycled plasterboard, perlite and recycled fibreglass insulation, or more preferably a mix of recycled plasterboard and gypsum, perlite and recycled insulation. One example comprises 70% perlite, 29% plaster and 1% fiberglass v/v basis.

From the supply point onwards, the bottom of the shell material rides on a profiled rail, and the top of the shell rides within a profiled groove, to occlude the windows 5′ to retain the liquid core material.

The liquid-filled shell portion is advanced through an oven 11 to set the core material. Downstream of the oven 11, the finished lengths of shell-core combination are severed from the continuous shell material at cutting station 13 and each comprises the shell 100 and a core 200.

Throughout the process, it is preferred that the continuous shell material is advanced at a constant rate although, in principle, the material might be advanced in stepwise fashion and this might simplify the punching station and cutting station 13.

According to this exemplary aspect of the disclosure, processing costs associated with handling and filling separate lengths of empty shell are avoided, as are the costs associated with allowing cementitious material to cure. The use of a single strip to form the shell portion is particularly advantageous although, in principle, an injector akin to the injector 9 could be arranged with its downward portion 9a′ upstream of a manipulating station at which two shell halves (or more than two shell portions) are brought together to define a tubular portion into which the nozzle 9b′ opens.

The present inventor has recognised that gypsum has various advantages over cementitious material. That the material can be set in an oven is convenient in the context of production processes such as the process 1. Moreover, the gypsum can be sourced from plasterboard that would otherwise go to waste, such as plasterboard from demolishing sites and plasterboard that has been damaged prior to installation. Advantageously, the core material may be substantially free of silica and the health risks associated therewith. Adding perlite (or other low-density filler) reduces the weight of the member and adding fibre (such as fibre recovered from waste fibreglass installation) increases toughness. Advantageously, preferred embodiments not only make use of recycled material but are themselves recyclable.

The shell 100 comprises a first side 101 and a second side 102. Between (and each mutually connecting) the first side and the second side is a tongue 103 and a groove 104. The tongue and groove have complementary forms such that multiple similar lengths can be mutually engaged to form a large panel.

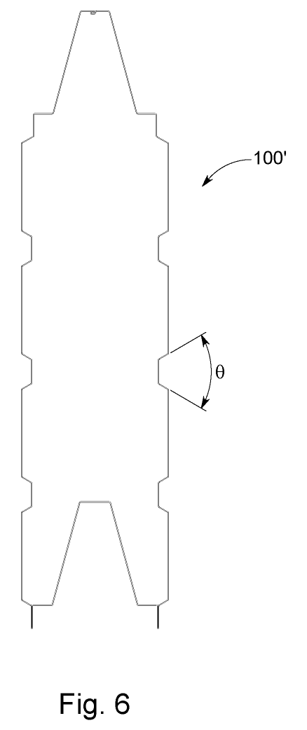

Each of the tongue and the groove is formed of lengthwise material that connects the first side 101 to the second side 102. Preferably, each side includes one or more stiffening grooves. The shell 100 has three square-profile grooves on each side. Preferably, the sides of each stiffening groove outwardly diverge – that is, diverge away from the centre of the shell. FIG. 6 illustrates a shell 100 in which the two sides of each stiffening groove outwardly diverge at an angle θ, which angle is preferably in the range of 45° to 75°, e.g. 60°.

In this example, the tongue and the groove are each trapezoidal and each comprise two major faces. Along each of the four major faces is a respective row of windows 5′. In this example, the windows 5′ are 20 mm x 35 mm cut-outs spaced at a pitch of 30 mm such that intervening material separating each adjacent two windows is 10 mm “wide” – that is, 10 mm parallel to the length of the member. As such, along a notional line along each row of openings, the cumulative length of the openings is twice the cumulative length of the intervening portions. In other words, in cross-section transverse to the row of windows, the amount of metal is reduced by two-thirds relative to a windowless version.

The present inventor has recognised that this arrangement of openings improves the performance of the fire-resistant wall by reducing thermal conduction through the wall and reducing thermally-induced deformation stress. The concept is not limited to tongue-and-groove members. By way of example, in the context of a member having a simple rectangular profile, holes running along the narrower faces would be useful.

The invention is not limited to the specific examples disclosed herein. Rather, the invention is defined by the claims.

The term “comprises” and its grammatical variants has a meaning that is determined by the context in which it appears. Accordingly, the term should not be interpreted exhaustively unless the context dictates so. Likewise, the article “a” or “an” preceding an element does not exclude the presence of a plurality of such elements unless the context dictates so.

What is claimed is:

1. A method of forming a member;
wherein the member comprises a length of shell-core combination for a fire-resistant wall and comprises a core within a shell;
wherein shell material comprises:
one or more continuous strips; and
a shell portion defining an interior and comprising a respective continuous extension of each respective continuous strip of the one or more continuous strips; and
the method comprising:
advancing the shell material in a streamwise direction and through a manipulation system;
the manipulation system manipulating the one or more continuous strips to form the shell portion;
supplying core material to the interior of the shell portion; and
severing an end portion from the shell portion; and
wherein the severing is downstream of the supplying.

2. The method of claim 1 wherein the supplying core material comprises supplying settable material.

3. The method of claim 2 wherein the severing is performed after the settable material within the end portion has set.

4. The method of claim 2 comprising heating to set the settable material within the end portion.

5. The method of claim 2 wherein the shell portion comprises:
a first side;
a second side;
lengthwise material connecting the first side to the second side and penetrated by openings; and
the method includes occluding the openings in the shell portion to retain the settable material.

6. The method of claim 1 wherein the one or more continuous strips is exactly one continuous strip.

7. A method of forming a member;
wherein the member comprises a length of shell-core combination for a fire-resistant wall and comprises a core within a shell;
wherein shell material comprises:
one or more continuous strips; and
a shell portion defining an interior and comprising a respective continuous extension of each respective continuous strip of the one or more continuous strips; and
the method comprising:
advancing the shell material in a streamwise direction and through a manipulation system;
the manipulation system manipulating the one or more continuous strips to form the shell portion;
severing an end portion from the shell portion; and
supplying core material; and
wherein the one or more continuous strips is exactly one continuous strip.

8. The method of claim 1 wherein the core material comprises at least one of gypsum and recycled fibreglass insulation.

9. The method of claim 1 wherein the core material comprises gypsum.

10. The method of claim 1 wherein the core material comprises recycled plasterboard.

11. The method of claim 1 wherein the core material comprises recycled fibreglass insulation.

12. The method of claim 1 wherein the core material comprises perlite.

13. The method of claim 1 wherein the shell comprises a metallic shell.

14. The method of claim 1 wherein the shell comprises a steel shell.

15. The method of claim 1 wherein the manipulating comprises roll-forming.

16. The method of claim 5 wherein
the openings comprise at least one row of openings along a notional lengthwise line;
along the notional lengthwise line the openings of the row are mutually separated by intervening shell material; and
a cumulative length, along the notional lengthwise line, of the openings is at 50% of a cumulative length, along the notional lengthwise line, of the intervening shell material.

17. The method of claim 16 wherein the cumulative length, along the notional lengthwise line, of the openings is at 100% of the cumulative length, along the notional lengthwise line, of the intervening shell material.

18. The method of claim 5, the member comprising:
a tongue; and
a groove for receiving the tongue of a like member;
wherein the openings penetrate at least one of
material of the tongue; and
material of the groove.

19. The method of claim 18 wherein the openings penetrate both:
the material of the tongue; and
the material of the groove.
